(19) United States
(12) Patent Application Publication
(10) Pub. No.: US 2012/0014696 A1
(43) Pub. Date: Jan. 19, 2012

(54) Novel wavelength allocation for RFoG/GPON/10GPON Coexistence on a single fiber

(76) Inventor: Oleh Sniezko, Highlands Ranch, CO (US)

(21) Appl. No.: 13/135,802

(22) Filed: Jul. 14, 2011

Related U.S. Application Data
(60) Provisional application No. 61/399,555, filed on Jul. 14, 2010.

(51) Int. Cl. H04J 14/02

(52) U.S. Cl. 398/79

(57) ABSTRACT

A method includes conveying a first set of signals including a plurality of first upstream signals within a first upstream wavelength region and a plurality of first downstream signals within a first downstream wavelength region; and conveying a second set of signals including a plurality of second upstream signals and a plurality of second downstream signals, wherein the plurality of second upstream signals and the plurality of second downstream signals are conveyed in a single contiguous wavelength region.

### CROSS-REFERENCE TO RELATED APPLICATION

This application claims a benefit of priority under 35 U.S.C. 119(e) from copending provisional patent application U.S. Ser. No. 61/399,555, filed Jul. 14, 2010, the entire contents of which are hereby expressly incorporated herein by reference for all purposes.

### BACKGROUND INFORMATION

1. Field of the Invention

Embodiments of the invention relate generally to the field of optical networking. More particularly, an embodiment of the invention relates to a wavelength allocation for RFoG/GPON/10GPON coexistence on a single fiber.

2. Discussion of the Related Art

Telephone companies such as Verizon and AT&T have started to offer fiber-to-the-premise (FTTP), fiber-to-the-home (FTTH) and fiber-to-the-curb (FTTC) systems such as FiOS™ and U-Verse™ that bring optical fiber to the home or close to home. In response, North American cable operators are selectively deploying fiber-to-the-home (FTTH) systems in new builds that can offer similar, or higher, bandwidths.

However, MSOs want to continue utilizing their flagship DOCSIS 3.0 wideband services, which provides for downstream data bandwidth up to 640 (or 800 in Europe) Mb/s, until such a time as yet higher data speeds are required. At such a time, the MSOs want the flexibility to upgrade their FTTH CPE device to handle Gb/s data speeds offered by passive optical networks (PONs) such as GPON or GEPON (both offering bandwidths of about 1 Gb/s).

RF over Glass (RFoG) is the name given to the generic FTTH architecture that supports both legacy DOCSIS cable return signals as well as a high speed (>1 Gb/s) PON service. One complication is that traditional cable return signals utilize a low-cost 1310 nm laser, which is the same wavelength as that used by upstream GPON/GEPON signals. The solution proposed in the RFoG standardization effort by SCTE has been to use a different wavelength, namely 1610 nm, to transport the cable return signal and 1310 nm to transport the upstream PON signal.

FIG. 1 shows the wavelength allocation of a typical RFoG system that allows for co-existence of traditional cable services as well as 1 Gb/s (2 Gb/s) EPON or 2.5 Gb/s GPON services. We shall use the generic term GPON/GEPON to describe both these services. The upstream/downstream wavelengths utilized are 1490 nm/1310 nm for the GPON/GEPON signals and 1610 nm/1550 nm for traditional cable services.

The fact that the two wavelengths for the GPON/GEPON service are below 1510 nm and the two wavelengths for the traditional cable service are above 1510 nm means that a simple red/blue optical filter (with 1510 nm as a transition wavelength, for example) can be used to inexpensively multiplex (or demultiplex) the two signals on a single fiber.

With the advent of 10 Gb/s PON services such as 10GPON and 10GEPON (both of which we shall refer to generically as 10GPON/GEPON) the wavelength allocation scheme gets more complicated. The upstream/downstream wavelengths proposed for the 10GPON/GEPON signals are 1270 nm/1577 nm. FIG. 2 shows the wavelength allocation of a typical RFoG system that allows for co-existence of traditional cable services as well as both GPON/GEPON and 10GPON/GEPON services on a single fiber.

A disadvantage of the wavelength allocation scheme shown in FIG. 2 is that the upstream and downstream RFoG wavelengths (1610 nm and 1550 nm, respectively) are separated by the downstream 10GPON/GEPON wavelength at 1577 nm. This means that multiplexing and demultiplexing of the RFoG signal with the other PON signals over a single fiber requires complicated and expensive optical filters. This additional cost is significant as it is related to customer premise equipment and multiplied by the number of customers.

### SUMMARY OF THE INVENTION

There is a need for the following embodiments of the invention. Of course, the invention is not limited to these embodiments.

According to an embodiment of the invention, a process comprises: conveying a first set of signals including a plurality of first upstream signals within a first upstream wavelength region and a plurality of first downstream signals within a first downstream wavelength region; and conveying a second set of signals including a plurality of second upstream signals and a plurality of second downstream signals, wherein the plurality of second upstream signals and the plurality of second downstream signals are conveyed in a single contiguous wavelength region. According to another embodiment of the invention, a machine comprises: a set of optical filters; and an optical conductor coupled to set of optical filters, the optical conductor i) conveying a first set of signals including a plurality of first upstream signals within a first upstream wavelength region and a plurality of first downstream signals within a first downstream wavelength region and ii) conveying a second set of signals including a plurality of second upstream signals and a plurality of second downstream signals, wherein the plurality of second upstream signals and the plurality of second downstream signals are conveyed in a single contiguous wavelength region.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 shows a typical wavelength allocation for an RFoG system that allows for co-existence of traditional cable and GPON/GEPON services.

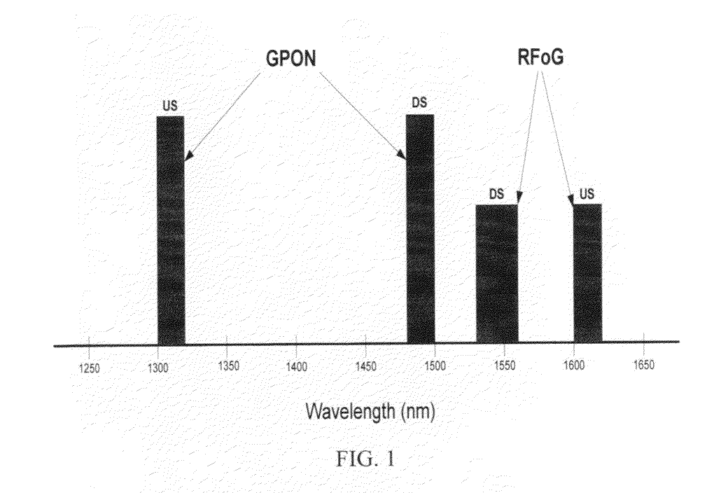

FIG. 2 shows a typical wavelength allocation for an RFoG system that allows for co-existence of traditional cable service with both GPON/GEPON and 10GPON/GEPON services.

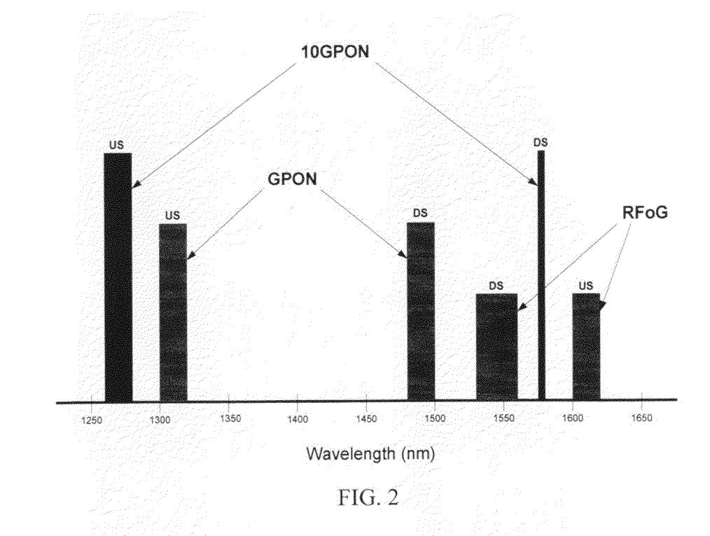

FIG. 3 shows a novel wavelength allocation scheme, with RFoG signals constrained to a single contiguous wavelength region in the C-Band.

FIG. 4 shows a novel wavelength allocation scheme, with RFoG signals constrained to a single contiguous wavelength region in the L-Band.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

This invention describes two novel wavelength allocation schemes that allow multiplexing and de-multiplexing of RFoG signals with GPON/GEPON and 10GPON/GEPON signals on a single fiber using much simpler and less expensive optical filters. This is done by constraining the upstream and downstream RFoG signals to a single contiguous (not separated by wavelength ranges allocated to other services) wavelength region, in either the C-Band (1530-1570 nm) or in the 1590-1625 nm region of the L-Band (above the 1575-1580 nm wavelength range allocated to the downstream 10GPON/GEPON signal) of an optical fiber.

With the new wavelength allocation described in this invention, it becomes practical to implement compatibility of the RFoG system with both GPON/GEPON and 10GPON/GEPON services at initial deployment without incremental cost and complexity that would be required to implement this compatibility and coexistence capability with the prior art wavelength allocation for RFoG services. This is enabled by much simpler and less expensive filters needed to accomplish this. These filters are similar (in complexity and cost) to the filters required to accomplish compatibility between GPON/GEPON services and RFoG services with the prior art wavelength allocation but significantly simpler than filters required to accomplish compatibility of the RFoG system with both GPON/GEPON and 10GPON/GEPON services with the prior art wavelength allocation.

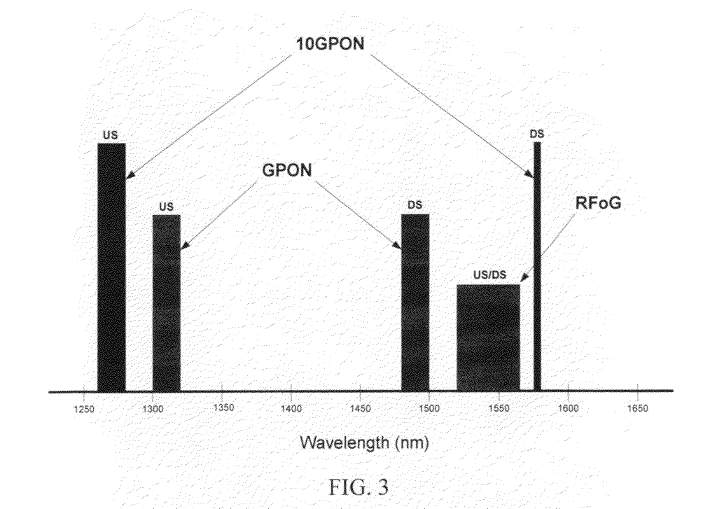

FIG. 3 shows one of the proposed wavelength allocation schemes, with the upstream and downstream RFoG signals constrained to a single contiguous wavelength region in the C-Band of an optical fiber.

The lower edge of the proposed RFoG band can be selected to be any wavelength in the interval 1530 nm±10 nm and the upper edge of the band could be any wavelength in the interval 1560 nm±10 nm. The selection of the lower edge wavelength depends on such factors as the isolation required between the RFoG signals and the GPON/GEPON downstream wavelength located at a nominal 1490 nm±10 nm, as well as optical amplifier parameters such as gain and flatness if a downstream RFoG signal uses this wavelength region. The selection of the upper edge wavelength depends on such factors as the isolation required between the RFoG signals and the 10GPON/GEPON downstream wavelength located in the wavelength interval 1575 nm-1580 nm, as well as optical amplifier parameters such as gain and flatness if a downstream RFoG signal uses this wavelength region. Optical filters to separate RFoG band from the PON bands is simpler and easier to manufacture with this novel wavelength allocation scheme. In one of its implementations, it could be a combination of two red/blue filters with different transition wavelengths. Other implementations are possible.

The RFoG wavelength band would be partitioned into two parts: one for the downstream RFoG signal and the other for the RFoG upstream signal. The downstream RFoG signal usually requires optical gain while the upstream signal does not. The determination of whether the downstream RFoG wavelength would reside in the lower or upper part of the RFoG band would depend on the required gain and flatness of the optical amplifiers used in the network and on the isolation requirements between the two downstream PON signals and RFoG downstream and upstream signals. If these two factors are not critical, this selection can be discretionary. The allocation of RFoG downstream (and related to it allocation of the RFoG upstream) signal to upper or lower part of the RFoG wavelength band would determine the isolation and directivity requirements for the optical filter separating PON and RFoG bands, and its cost.

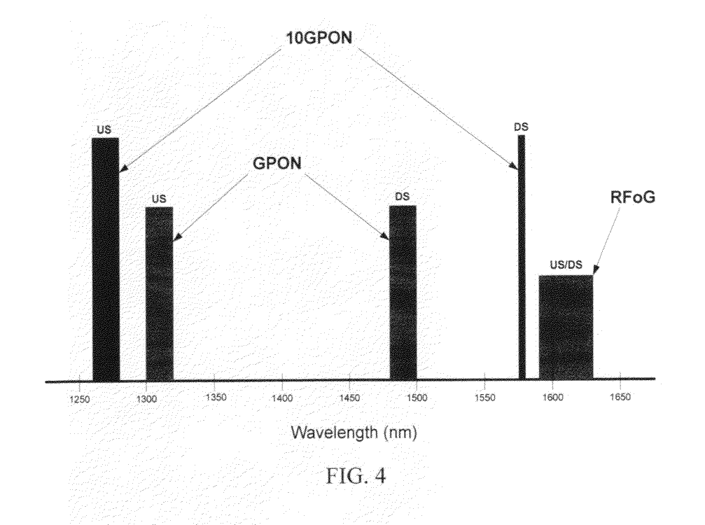

Downstream RFoG signaling conventionally utilizes 1550 nm externally-modulated and directly-modulated transmitters and C-Band optical amplifiers. There is no technical reason, however, that this could not be done in the L-Band using L-Band optical amplifiers and transmitters. FIG. 4 shows the other proposed wavelength allocation scheme, with the upstream and downstream RFoG signals constrained to a single contiguous wavelength region in the L-Band of an optical fiber.

The lower edge of the proposed RFoG band can be selected to be any wavelength in the interval 1600 nm ±10 nm and the upper edge of the band could be any wavelength in the interval 1620 nm ±10 nm. The selection of the lower edge wavelength depends on such factors as the isolation required between the RFoG signals and the 10GPON/GEPON downstream wavelength located in the wavelength interval 1575-1580 nm, as well as optical amplifier parameters such as gain and flatness. The selection of the upper edge wavelength depends on availability of lasers and on optical amplifier parameters such as gain and flatness.

The fact that the RFoG signal is at higher wavelengths than the other services being transported over the same fiber means that a simple red/blue optical filter (with 1590 nm as a transition wavelength, for example) can be used to inexpensively multiplex (or demultiplex) the RFoG signal and the PON signals (both GPON/GEPON and 10GPON/GEPON) together on the fiber.

The RFoG wavelength band would be partitioned into two parts: one for the downstream RFoG signal and the other for the RFoG upstream signal. The determination of whether the downstream RFoG wavelength would reside in the lower or upper part of the RFoG band would depend on the required gain and flatness of the optical amplifiers used in the network and isolation requirements. If no optical amplifiers are used, then the downstream wavelength could be in either the lower or upper part of the RFoG wavelength band. However, if L-Band optical amplifiers are utilized in the network, it would be advantageous to place the downstream RFoG signal in the lower part of the RFoG wavelength band since L-Band optical amplifiers normally have higher gain here than in the long-wavelength part of the L-Band. The allocation of RFoG downstream (and related to it allocation of the RFoG upstream) signal to upper or lower part of the RFoG wavelength band would determine the isolation and directivity requirements for the red/blue optical filter and its cost.

### EXAMPLES

Specific embodiments of the invention will now be further described by the following, nonlimiting examples which will serve to illustrate in some detail various features. The following examples are included to facilitate an understanding of ways in which an embodiment of the invention may be practiced. It should be appreciated that the examples which follow represent embodiments discovered to function well in the practice of the invention, and thus can be considered to constitute preferred mode(s) for the practice of the embodiments of the invention. However, it should be appreciated that many changes can be made in the exemplary embodiments which are disclosed while still obtaining like or similar result without departing from the spirit and scope of an embodiment of the invention. Accordingly, the examples should not be construed as limiting the scope of the invention.

### Example 1

The invention can including allowing coexistence of RFoG, GPON/GEPON and 10GPON/GEPON signals on a single fiber using simple and inexpensive optical filters whereby both downstream and upstream RFoG wavelengths lie in a contiguous wavelength band, with the lower edge lying in the interval 1530 nm ±10 nm and the upper edge lying in the interval 1560 nm ±10 nm. The selection of the lower edge wavelength can be varied within the specified interval depending on such factors as the isolation required between the RFoG signals and the GPON/GEPON downstream wavelength located at a nominal 1490 nm ±10 nm, as well as optical amplifier parameters such as gain and flatness. The selection of the upper edge wavelength can be varied within the specified interval depending on such factors as the isolation required between the RFoG signals and the 10GPON/GEPON downstream wavelength located in the wavelength interval 1575 nm-1580 nm, as well as optical amplifier parameters such as gain and flatness. The determination of whether the downstream RFoG wavelength would reside in the lower or upper part of the RFoG band would depend on the required gain and flatness of the optical amplifiers used in the network and isolation between PON and RFoG signals.

### Example 2

The invention can include allowing coexistence of RFoG, GPON/GEPON and 10GPON/GEPON signals on a single fiber using simple and inexpensive optical filters whereby both downstream and upstream RFoG wavelengths lie in a contiguous wavelength band, with the lower edge lying in the interval 1600 nm ±10 nm and the upper edge lying in the interval 1620 nm ±10 nm. The selection of the lower edge wavelength can be varied within the specified interval depending on such factors as the isolation required between the RFoG signals and the 10GPON/GEPON downstream wavelength located in the wavelength interval 1575-1580 nm, as well as optical amplifier parameters such as gain and flatness. The selection of the upper edge wavelength can be varied within the specified interval depending on availability of lasers and on optical amplifier parameters such as gain and flatness. The determination of whether the downstream RFoG wavelength would reside in the lower or upper part of the RFoG band would depend on the required gain and flatness of the optical amplifiers used in the network. If no optical amplifiers are used, then the downstream wavelength could be in either the lower or upper part of the RFoG wavelength band. However, if L-Band optical amplifiers are utilized in the network, it would be advantageous to place the downstream RFoG signal in the lower part of the RFoG wavelength band to take advantage of the higher gain of L-Band optical amplifiers typically observed in the lower part of the L-Band. Isolation requirements between RFoG and PON signals will also affect the determination of the placement of the RFoG signals within the RFoG band.

### Definitions

The phrase single contiguous wavelength region is intended to mean not separated by wavelength ranges allocated to other services. The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### Conclusion

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein.

The individual steps of embodiments of the invention need not be performed in the disclosed manner, or combined in the disclosed sequences, but may be performed in any and all manner and/or combined in any and all sequences.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising
conveying a first set of signals including a plurality of first upstream signals within a first upstream wavelength region and a plurality of first downstream signals within a first downstream wavelength region; and
conveying a second set of signals including a plurality of second upstream signals and a plurality of second downstream signals,
wherein the plurality of second upstream signals and the plurality of second downstream signals are conveyed in a single contiguous wavelength region.

2. The method of claim 1, wherein the single contiguous wavelength region is the C-Band of an optical fiber.

3. The method of claim 1, wherein the single contiguous wavelength region is between the first upstream wavelength region and the first downstream wavelength region.

4. The method of claim 1, wherein the single contiguous wavelength region is the L-Band of an optical fiber.

5. The method of claim 1, wherein the single contiguous wavelength region is above both the first upstream wavelength region and the first downstream wavelength region.

6. The method of claim 1, further comprising conveying a third set of signals including a plurality of third upstream signals within a third upstream wavelength region and a plurality of third downstream signals within a third downstream wavelength region.

7. The method of claim 1, wherein both the third upstream wavelength region and the third downstream wavelength region are between the first upstream wavelength region and the first downstream wavelength region.

8. A computer program, comprising computer or machine readable program elements translatable for implementing the method of claim 1.

9. A machine readable medium, comprising a program for performing the method of claim 1.

10. An apparatus, comprising:
a set of optical filters; and
an optical conductor coupled to set of optical filters, the optical conductor i) conveying a first set of signals including a plurality of first upstream signals within a first upstream wavelength region and a plurality of first downstream signals within a first downstream wavelength region and ii) conveying a second set of signals including a plurality of second upstream signals and a plurality of second downstream signals, wherein the plurality of second upstream signals and the plurality of second downstream signals are conveyed in a single contiguous wavelength region.

11. The apparatus of claim 10, wherein the conductor includes an optical fiber.

12. A network, comprising the apparatus of claim 10.
